(19) United States
(12) Patent Application Publication
(10) Pub. No.: US 2007/0193702 A1
(43) Pub. Date: Aug. 23, 2007

(54) Apparatus for moving air shutter slats up and down

(76) Inventor: Jin-Tang Hung, Chiai City (TW)

Correspondence Address: BIRCH STEWART KOLASCH & BIRCH, PO BOX 747, FALLS CHURCH, VA, 22040-0747, US

(21) Appl. No.: 11/359,546

(22) Filed: Feb. 23, 2006

(51) Int. Cl. E06B 9/30

(52) U.S. Cl. 160/172 R

(57) ABSTRACT

An apparatus capable of moving air shutter slats up and down includes a rectangular frame and a plurality of slats. The frame has a left slot and a right slot on a left inner side and a right inner side. The left slot and the right slot have respectively at least one latch notch on a corresponding horizontal position. The slats are fastened by a strap on the front side and rear side, and have respectively a stub shaft on the left end and the right end that are inserted into the left slot and right slot for turning therein. The slats can be moved up and down in the frame, and the stub shaft can be wedged in the latch notch to anchor the slats.

### FIELD OF THE INVENTION

The present invention relates to an air shutter slat and particularly to an air shutter slat that is movable up and down.

### BACKGROUND OF THE INVENTION

Referring to FIGS. 1 and 2, a conventional air shutter 1 mainly includes a frame 2 and a plurality of slats 3 located in the frame 2 that are equally spaced from one another. Each of the slats 3 has a left end and a right end hinged on the frame 2 for turning the slat. The slats 3 are jointly coupled with a drawing bar 4 in the middle on the front end. When the drawing bar 4 is moved downwards as shown in FIG. 2, the slats 3 are pulled synchronously downwards in a diagonal manner and overlapped like fish scales to block light. When the drawing bar 4 is moved upwards, the slats 3 can be moved to become horizontal to allow outdoor light to enter through the intervals of the slats 3. Outdoor air also can flow indoors to facilitate air circulation.

However, the conventional air shutter 1 mentioned above has one drawback, namely the intervals of the slats 3 cannot be fully closed even when the drawing bar 4 has been moved to the lowest position. To remedy the aforesaid problem, an improved air shutter 5 is developed as shown in FIGS. 3 and 4. It has a rectangular frame 6 with an opening formed in the center. The opening of the frame 6 holds a plurality of slats 7 from up and down in an equally spaced manner. Each of the slats 7 has two ends hinged on a left and a right inner side of the frame 6 so that each slat 7 can be turned to an angle as desired. The left side and right side of each slat 7 further are fastened by an annular strap 8. Turning any one slat 7 will move the strap 8 which drives all slats 7 to turn together. Hence the slats 7 can be turned synchronously diagonally, or in a closed or open manner

The strap 8 is a pliable fabric, and can be turned with any turning slat 7 to allow the slats to form a diagonal and overlapped condition on the top and bottom end as shown in FIG. 4. Thus the interval between any two neighboring slats 7 can be reduced to minimum to prevent air circulation.

However, both structures set forth above have the slats permanently hinged on the frame at fixed locations. Such structures affect passing of light and result in reduced maximum light projection. Hence they cannot fully meet user's requirements.

### SUMMARY OF THE INVENTION

Therefore the primary object of the present invention is to provide an apparatus that is capable of moving air shutter slats up and down to enable users to move the slats as desired to generate required light projection.

The apparatus according to the invention includes a frame and a plurality of slats. The frame has a left slot and a right slot on a left inner side and a right inner side. The left slot and right slot have respectively at least one latch notch located on a corresponding horizontal position. The slats are fastened by a strap on a front side and a rear side, and have respectively a stub shaft on a left end and a right end. The stub shaft is inserted in the left slot and the right slot so that the slats are turnable. The slats also can be moved up and down on the frame with the stub shaft latching on the latch notch for anchoring.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional air shutter in an open condition.

FIG. 2 is a schematic view of a conventional air shutter in a closed condition.

FIG. 3 is a schematic view of another conventional air shutter in an open condition.

FIG. 4 is a schematic view of another conventional air shutter in a closed condition.

FIG. 5 is an exploded view of the air shutter slat structure of the present invention.

FIG. 6A is a perspective view of the air shutter slat structure of the present invention in an assembled condition.

FIG. 6B is a cross section taken on line 6B-6B in FIG. 6A.

FIGS. 7A through 7C are sectional views of the invention with the slats moving downwards.

FIGS. 8A through 8C are sectional views of the invention with the slats moving upwards.

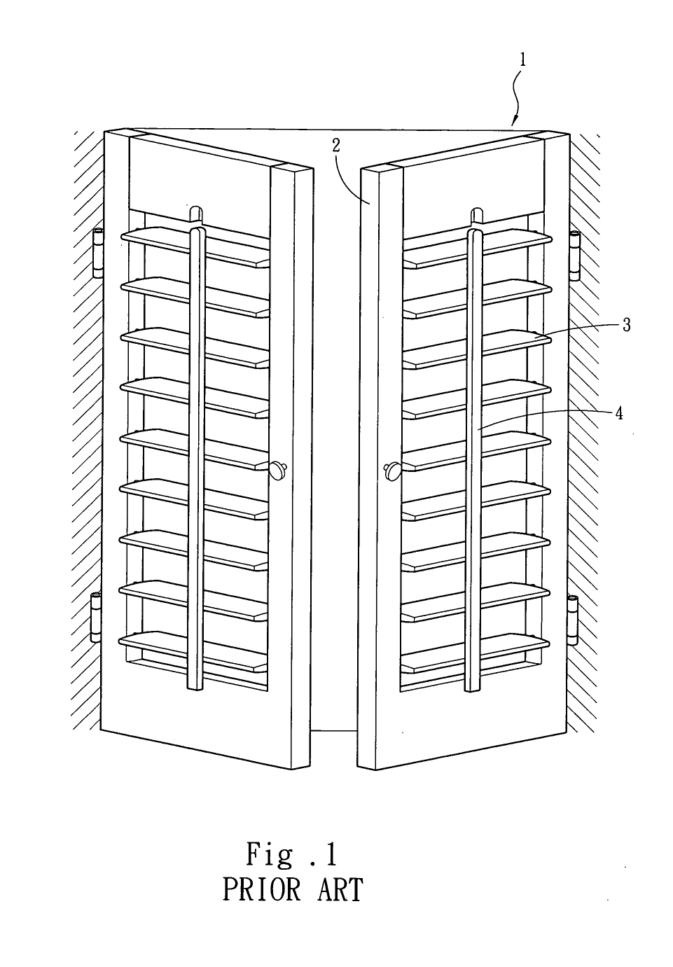

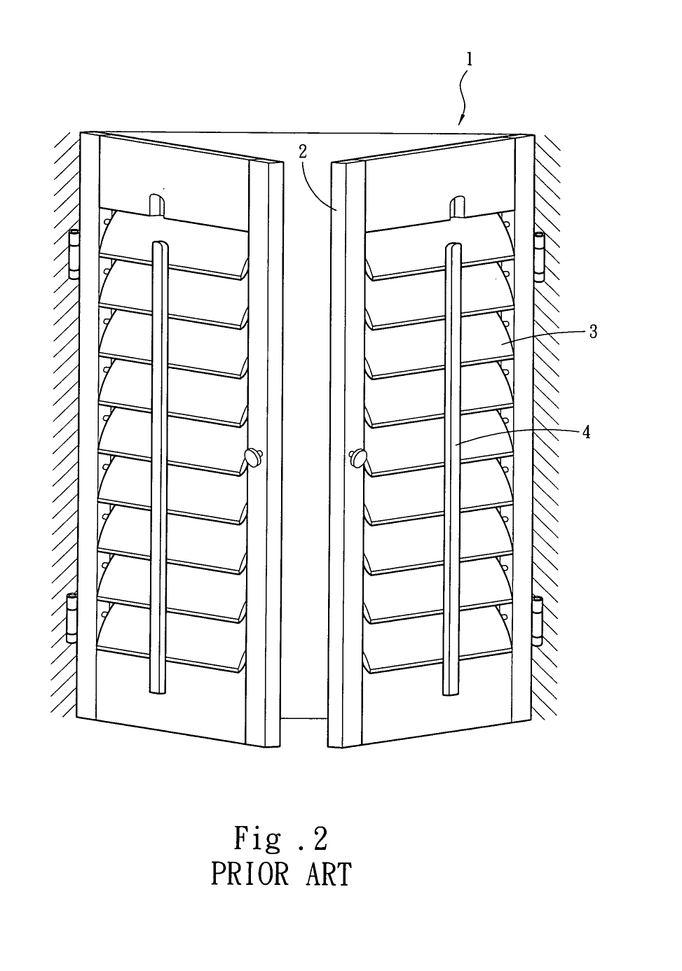

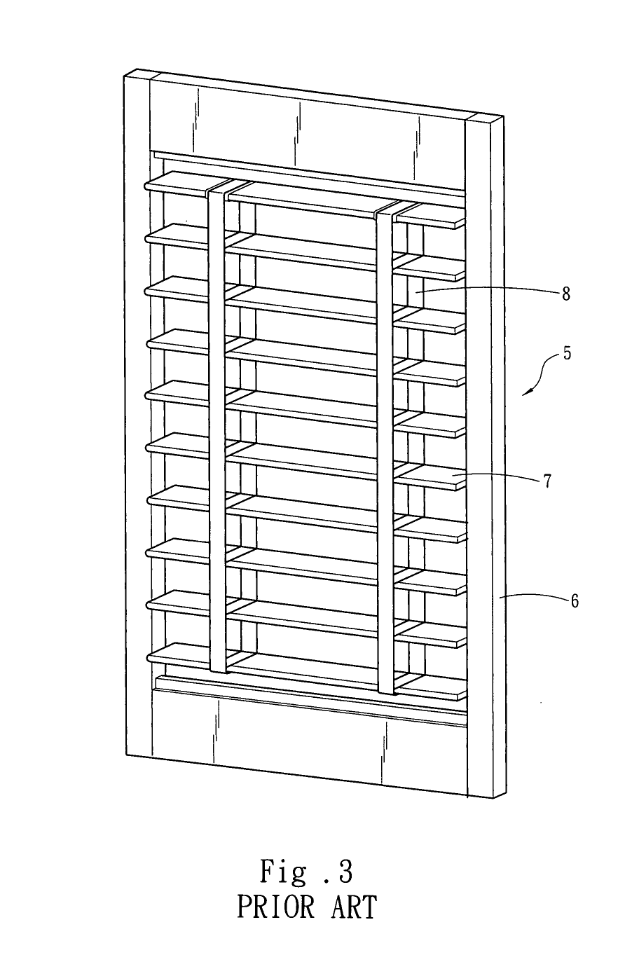

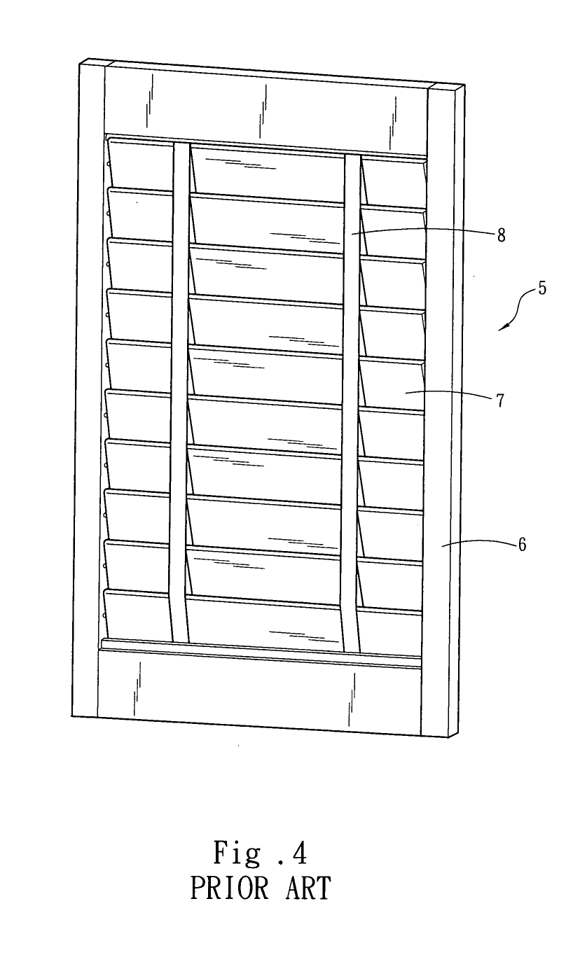

### DETAILED DESCRIPTION OF THE PREFERRED EMBODIMENT

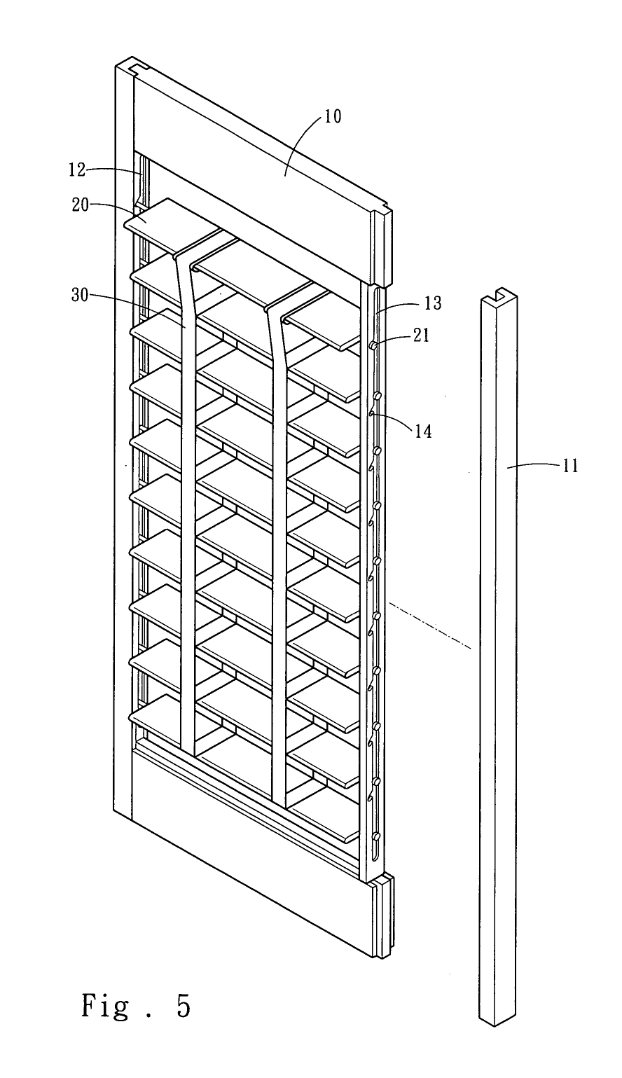

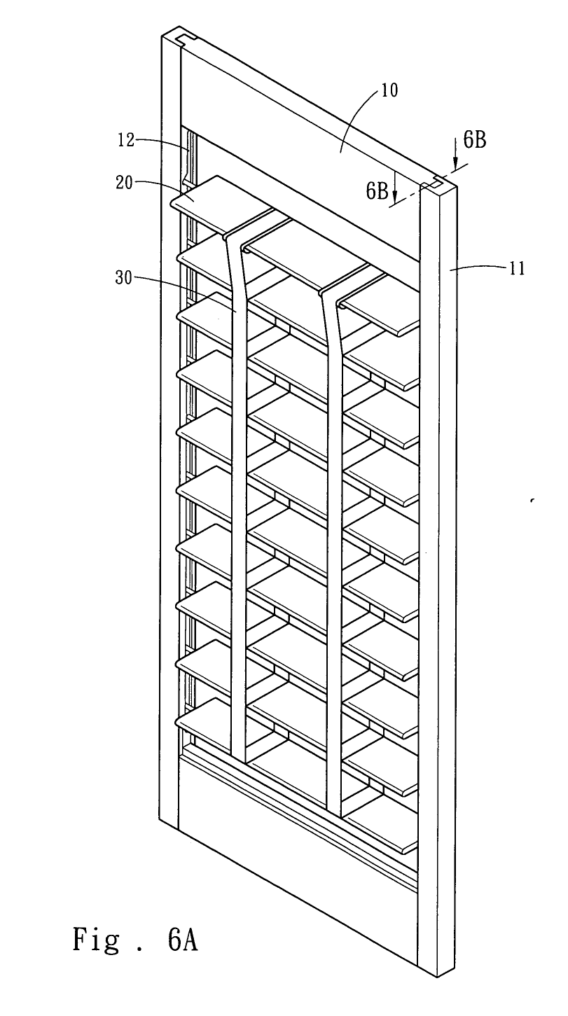

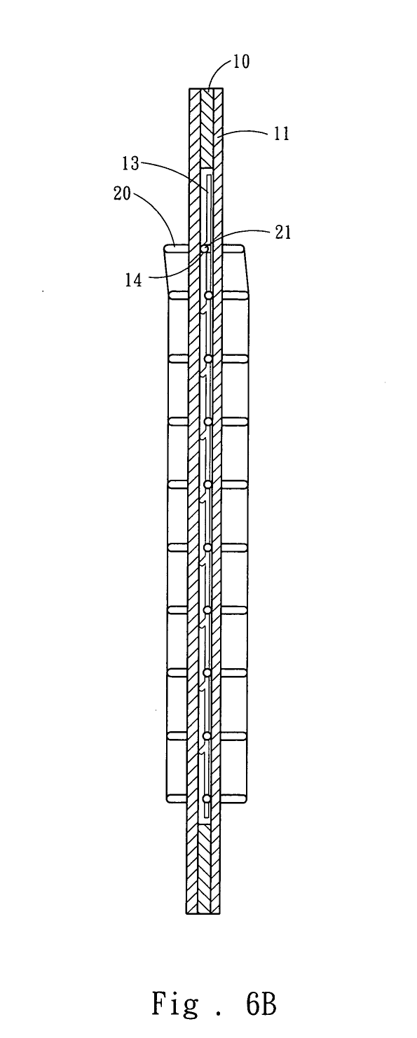

Please referring to FIGS. 5, 6A and 6B, the present invention includes a frame 10 and a plurality of slats 20. The frame 10 has a left slot 12 and a right slot 13 on a left inner side and a right inner side. The left slot 12 and the right slot 13 have respectively at least one latch notch 14 on a corresponding horizontal position. The slats 20 are fastened by a strap 30 on a front side and a rear side, and have respectively a stub shaft 21 on a left end and a right end to insert into the left slot 12 and the right slot 13 to be turn therein, also allow the slats 20 to be moved up and down in the frame 10. The invention further has a frame cover 11 located on the left side and right side of the frame to cover the left slot 12 and the right slot 13 to make the entire body more appealing.

In practice, the number and interval of the latch notch 14 may be altered according to user's requirements. The distance between the top latch notch 14 and the top end of the left slot 12 and right slot 13 can accommodate all the slats 20. The distance between the bottom latch notch 14 and the bottom end of the left slot 12 and right slot 13 also can accommodate all the slats 20.

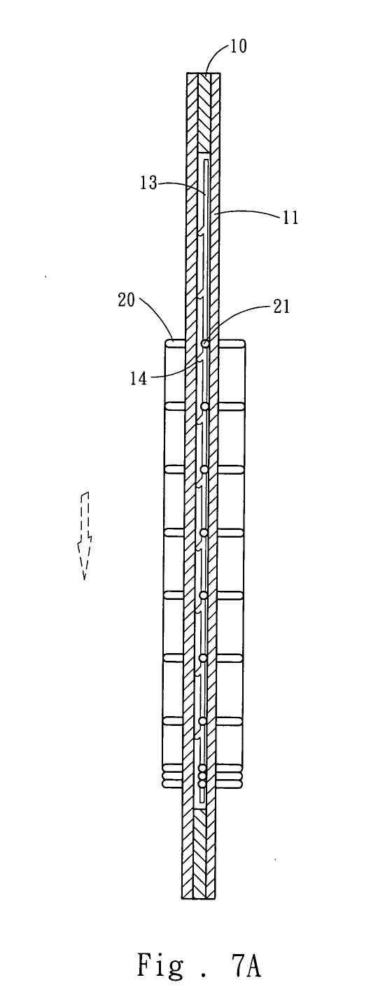

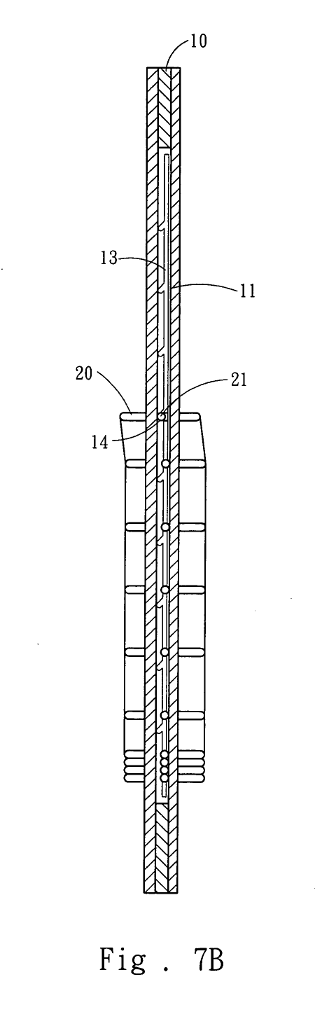

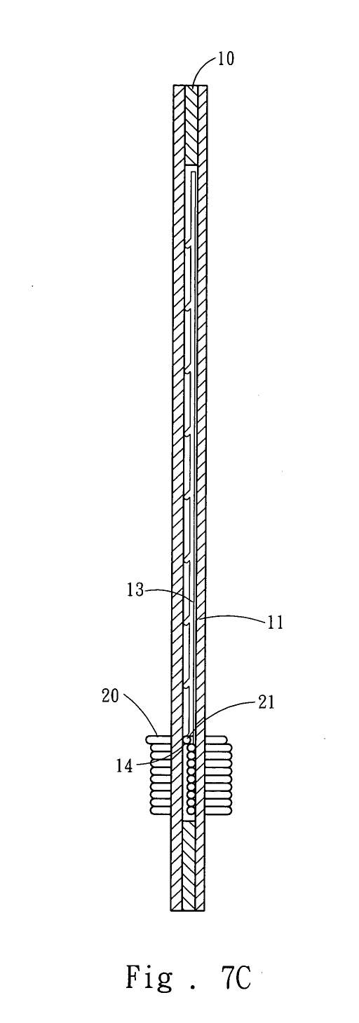

Refer to FIGS. 7A through 7C for the invention in the conditions of moving downwards. Initially, the stub shaft 21 of the top slat 20 is slid and anchored on the latch notch 14 at the top end (also referring to FIG. 6B); the slats 20 are dragged by the strap 30 and suspended on the frame 10. Users can turn one of the slats 20 according to requirements to drive the rest slats 20 to turn synchronously, therefore to change the interval between the slats 20.

To move the slats 20 downwards, remove the stub shaft 21 of the top slat 20 away from the latch notch 14 at the top end, then the slats 20 can be moved downwards (as shown in FIG.7A) to a desired elevation, then latch the stub shaft 21 of one slat 20 to a mating latch notch 14 for anchoring (referring to FIG. 7B). The slats 20 can also be directly moved to the bottom. This is accomplished by latching the stub shaft 21 of the top slat 20 to the latch notch 14 at the bottom (referring to FIG. 7C). Then the frame 10 is not covered by the slats 20, and maximum light projection and air circulation can be achieved.

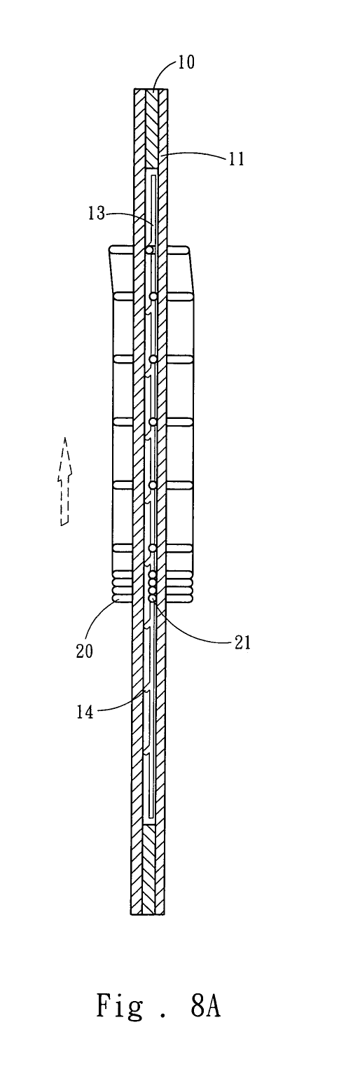

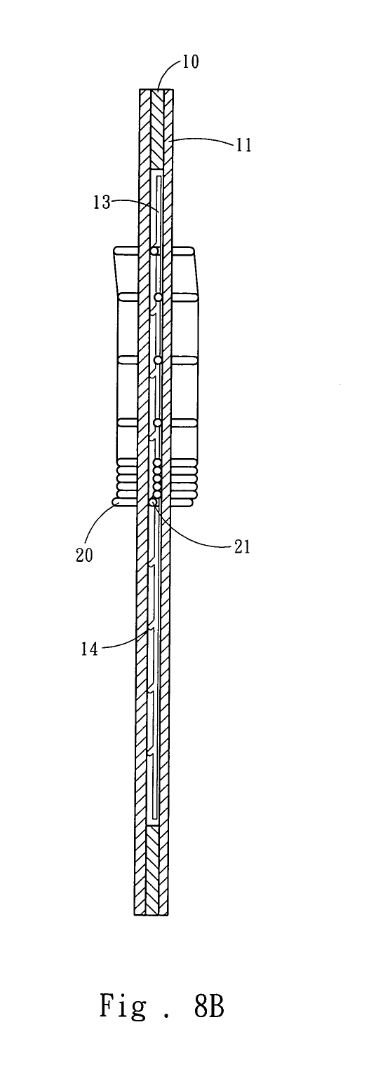

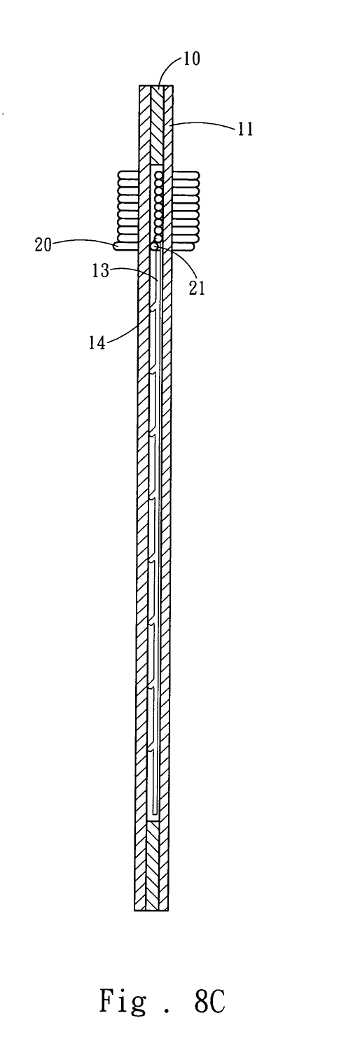

Refer to FIGS. 8A through 8C for the invention in the conditions of moving upwards. Initially, the stub shaft 21 of the top slat 20 is slid and anchored on the latch notch 14 at the top end (also referring to FIG. 6B).To move the slats 20 upwards, move the stub shaft 21 of the bottom slat 20 upwards (referring to FIG. 8A) to a desired elevation, then latch the stub shaft 21 of one slat 20 to a mating latch notch 14 for anchoring (referring to FIG. 8B). The slats 20 can also be directly moved to the top. This is accomplished by removing the stub shaft 21 of the top slat 20 from the latch notch 14 at the top, then latch the stub shaft 21 of the bottom slat 20 in the latch notch 14 at the top (referring to FIG. 8C). Then the frame 10 is not covered by the slats 20, and maximum light projection and air circulation can be achieved.

What is claimed is:

1. An apparatus for moving air shutter slats up and down, comprising:
a frame which includes a left slot on an left inner side and a right slot on a right inner side that have respectively at least one latch notch on a corresponding horizontal position; and
a plurality of slats which are fastened by a strap on a front side and a rear side and have respectively a stub shaft on a left end and a right end to insert into the left slot and the right slot for turning therein, the slats being movable up and down in the frame, the stub shaft being engageable with the latch notch to anchor the slats.

2. The apparatus of claim 1, wherein the distance between the latch notch at the top and the top ends of the left slot and the right slot can accommodate all the slats.

3. The apparatus of claim 1, wherein the distance between the latch notch at the bottom and the bottom ends of the left slot and the right slot can accommodate all the slats.

4. The apparatus of claim 1 further having a frame cover located on left side and right side of the frame to cover the left slot and the right slot.
